(19) United States
(12) Patent Application Publication
(10) Pub. No.: US 2011/0134641 A1
(43) Pub. Date: Jun. 9, 2011

(54) COMPOSITE STRUCTURE FOR POLYGONAL LIGHT-EMITTING DIODE

(76) Inventor: Hong-Yuan CHEN, Taipei (TW)

(21) Appl. No.: 12/632,414

(22) Filed: Dec. 7, 2009

(51) Int. Cl. F21S 4/00

(52) U.S. Cl. 362/249.06

(57) ABSTRACT

The present invention relates to a composite structure for polygonal LED, enabling operation to be carried out using a transformer to control a LED (light-emitting diode) module assembly. The LED module assembly is mainly assembled from a plurality of polygonal LED modules, in which the lengths of the sides of the LED modules enable corresponding combination thereof, thereby enabling the LED modules to be mutually connected together from any one of the sides. Accordingly, the user is able to carry out assembly or fixedly joining together of the LED modules according to needs or preference, thereby achieving advancement in a LED module assembly providing high expansionability, high luminance, superior area light source, low cost and the ability to be controlled using one transformer.

### BACKGROUND OF THE INVENTION

(a) Field of the Invention

The present invention provides a polygonal LED (light-emitting diode), and more particularly provides a composite structure for polygonal LED which enables multivaried assembly of a plurality of polygonal LED modules, providing high expansionability and high variability, and further achieving saving in time and cost.

(b) Description of the Prior Art

Because the light-emitting diode (LED) is a solid-state semiconductor element, thus, interoperability of electron holes is used to release energy in light form, and belongs to luminescence. Moreover, advantages of the LED include small size, fast response speed, long serviceable life, low power consumption, superior shock resistance and non-polluting. Light-emitting elements are presently already widely utilized in many areas, including electric appliances, information billboards, communication products, and the like, in particular, current lighting equipment which use light-emitting diodes as light-emitting elements. Although the efficiency of the first light-emitting diodes was lower than anticipated compared with traditional lighting equipment, however, subsequent improvements in technology and material have brought about substantial progress in the luminance brightness of light-emitting diodes currently manufactured, which has affected the gradual replacement of traditional light-emitting elements.

Manufacturing processes of LED modules of the prior art involve first separately encapsulating the LEDs to form LED encapsulated structures, after which the electrodes of the LEDs are welded to a baseplate using surface mounting technology (SMT) to form electrical circuits, thereby producing the LED module, in which the baseplate is normally a printed circuit board (PCB).

However, expansion of such LED modules cannot be carried out, and, after fixedly welding, connective expansion of most of such LED modules cannot be increased. Hence, the LED modules must be completely replaced when a user wants to increase the number of LED modules, which places enormous demands on cost, thus, insufficient expansionability increases cost, as well as requiring time to replace the LED modules. Thus, there are a multitude of reasons preventing advancement in industrial competitiveness.

Moreover, one module among the set of LED modules cannot be singularly replaced if there is a fault or operating efficiency is poor in the one module, and the entire set of modules must be replaced. Thus, such LED modules are extremely ineffective with respect to cost and time.

Hence, it is the strong desire of the inventor and manufacturers engaged in related art and purpose of the present invention to research, improve and resolve the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements, has designed a new composite structure for polygonal LED (light-emitting diode) as disclosed in the present invention which enables multivaried assembly of a plurality of polygonal LED modules, providing high expansionability and high variability, and further achieving saving in time and cost.

The primary objective of the present invention lies in the composite structure comprising a transformer and a LED module assembly, in which the transformer is electrically connected to the LED module assembly to enable controlling the LED module assembly, and the LED module assembly is structurally assembled from a plurality of polygonal LED modules. The lengths of sides of the LED modules enable corresponding combination thereof, thereby enabling the LED modules to be mutually connected together from any one of the sides. Accordingly, when a user wants to expand the LED modules, then the sides of the LED module are used to mutually connect to the sides of another of the LED modules. Connecting means can use screw tightening, solder joining, insertion fastening, drive fitting or adhesive affixing to fixedly connect the LED modules together. According to the art described above, the present invention provides a breakthrough in solving the existing problems of advancement in industrial competitiveness because of a multitude of reasons, including the inability to carry out expansion of LED modules of the prior art, and, after fixedly welding, connective expansion of most of such LED modules cannot be increased, thus, requiring the LED modules to be completely replaced when a user wants to increase the number of LED modules, thereby placing enormous demands on cost, and increasing cost because of insufficient expansionability, as well as requiring time to replace the LED modules; moreover, one module among the set of LED modules cannot be singularly replaced if there is a fault or operating efficiency is poor in the one module, and the entire set of modules must be replaced; hence, such LED modules of the prior art are extremely ineffective with respect to cost and time. The present invention achieves the breakthrough by using the lengths of the sides of the LED modules to enable corresponding combination thereof, thereby enabling the LED modules to be mutually connected together from any one of the sides. Hence, the user is able to carry out assembly or fixedly joining together of the LED modules according to needs or preference, thereby achieving advancement in a LED module assembly providing high expansionability, high luminance, superior area light source, low cost and the ability to be controlled using one transformer.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational view of a LED module assembly of the present invention.

FIG. 2 is a block diagram of a preferred embodiment of the present invention.

FIG. 3 is a schematic view of the preferred embodiment depicting joining together of the LED modules according to the present invention.

FIG. 4 is an implementation schematic view of a first preferred embodiment of the present invention.

FIG. 5 is an implementation schematic view of a second preferred embodiment of the present invention.

FIG. 6 is an exploded view of the second preferred embodiment of the present invention.

### DETAILED DESCRIPTION OF THE PREFERRED EMBODIMENTS

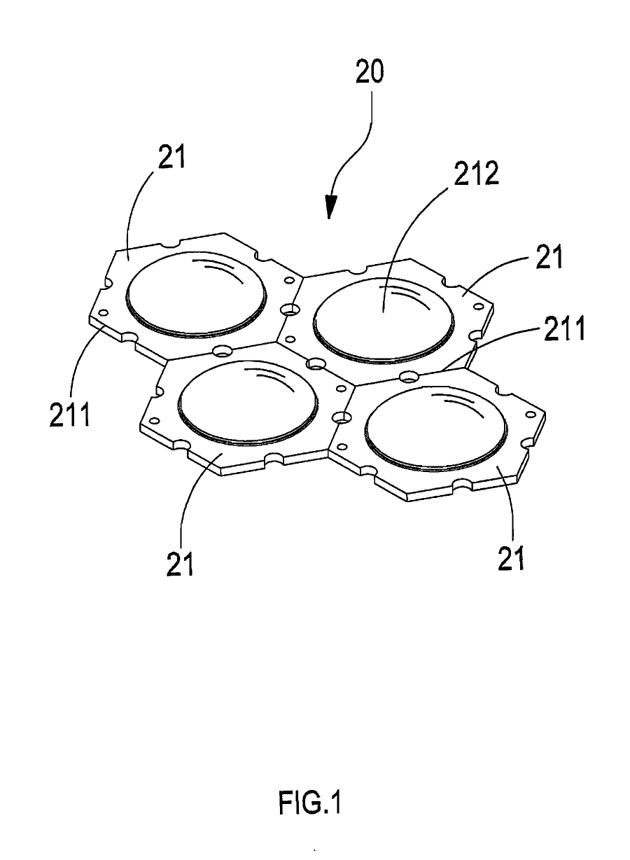

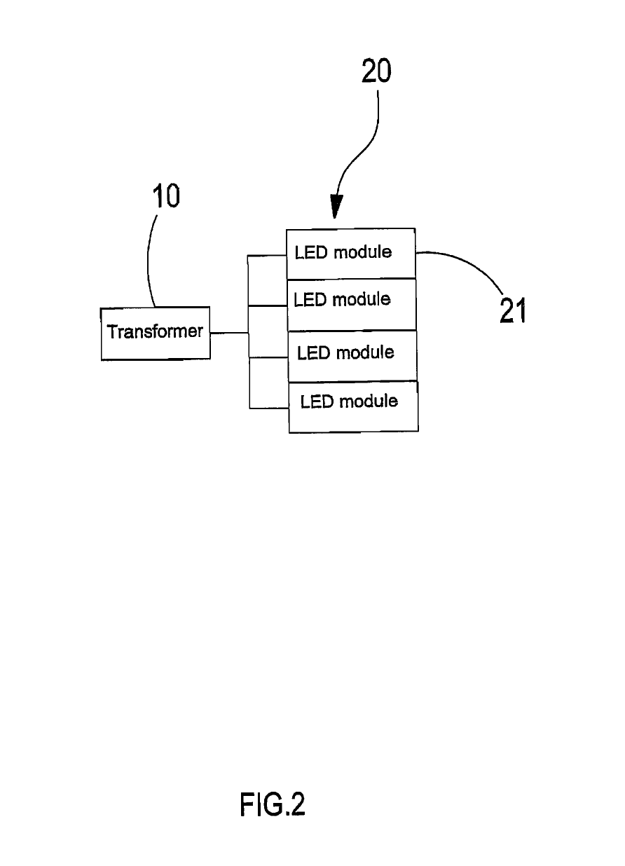

Referring to FIG. 1 and FIG. 2, which show an elevational view of a LED (light-emitting diode) module assembly of the present invention and a block diagram of a preferred embodiment of the present invention respectively, and it can be clearly seen from the drawings that the present invention comprises a transformer 10 controlling a LED module assembly 20. The present invention is characterized in that the LED module assembly 20 is a composite structure from a plurality of polygonal LED modules 21, in which each of the LED modules 21 comprises at least one LED light-emitting element 212. The lengths of sides 211 of the LED modules 21 enable corresponding combination thereof, thereby enabling the LED modules 21 to be mutually connected together from any one of the sides 211. And a multitude of different forms can be configured by connective expansion of the sides 211 of the LED modules 21, thereby increasing the area light source.

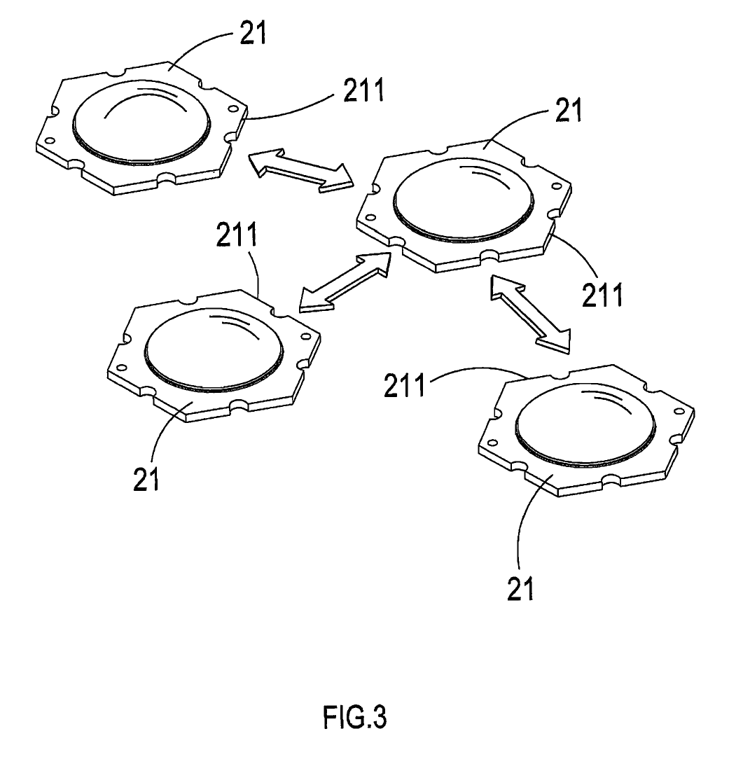

According to the aforementioned structure and constructional design, the circumstances during operational use of the present invention are described hereinafter. Referring together to FIG. 2 and FIG. 3, which show the block diagram of the preferred embodiment of the present invention and a schematic view depicting joining of the LED module respectively, and it can be clearly seen from the drawings that the composite structure comprises the transformer 10 and the LED module assembly 20, in which the transformer 10 is electrically connected to the LED module assembly 20, thereby enabling the transformer 10 to control the LED module assembly 20. The LED module assembly 20 is structurally assembled from a plurality of polygonal LED modules 21, and the lengths of the sides 211 of the LED modules 21 enable corresponding combination thereof, thereby enabling the LED modules 21 to be mutually connected together from any one of the sides 211. When a user wants to expand the LED modules 21, then the sides 211 of the LED module 21 can be used to mutually connect to the sides 211 of another of the LED modules. Connecting means can use screw tightening, solder joining, insertion fastening, drive fitting or adhesive affixing to fixedly connect the LED modules 21 together, thereby enabling free expansion of the LED modules 21 by the user without the need for additional installation of transformers 10 to control the LED modules 21.

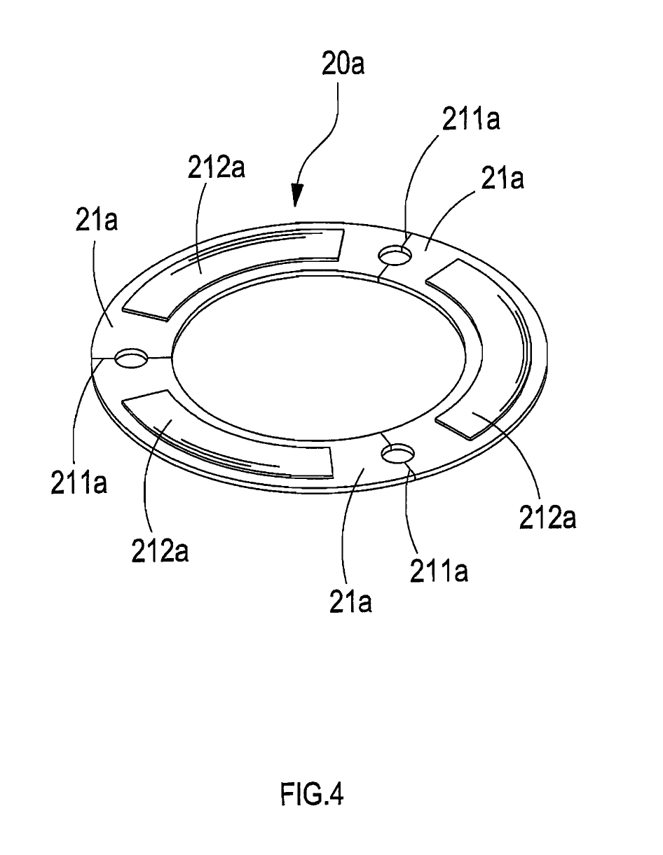

Referring to FIG. 4, which shows an implementation schematic view of a first preferred embodiment of the present invention, and it can be clearly seen from the drawing that a LED module assembly 20a is structurally assembled from a plurality of polygonal LED modules 21a, and the LED modules 21a respectively comprise at least one LED light-emitting element 212a. The lengths of sides 211a of the each of the LED modules 21a enable corresponding combination thereof to complete assembly of different types of figures, such as: ring type (but is not limited to such a combination arrangement nor is the number of LED light-emitting elements 212a limited).

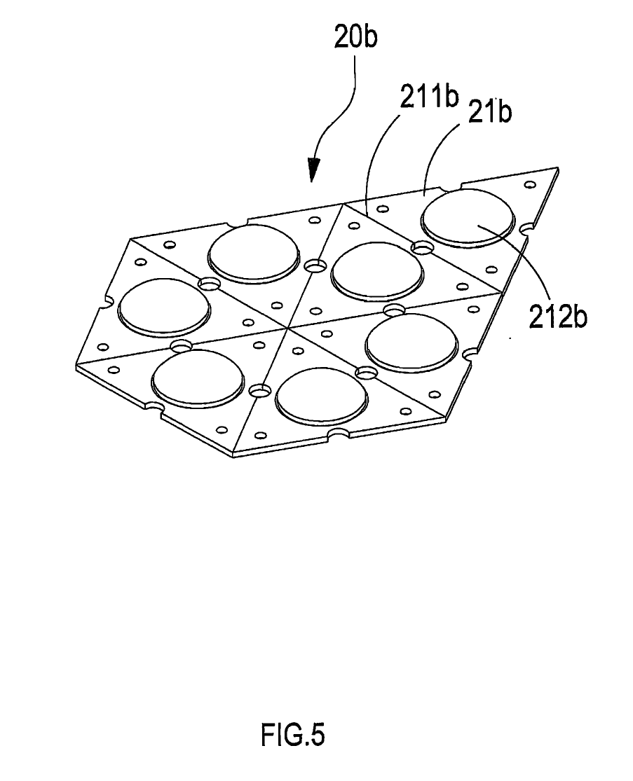

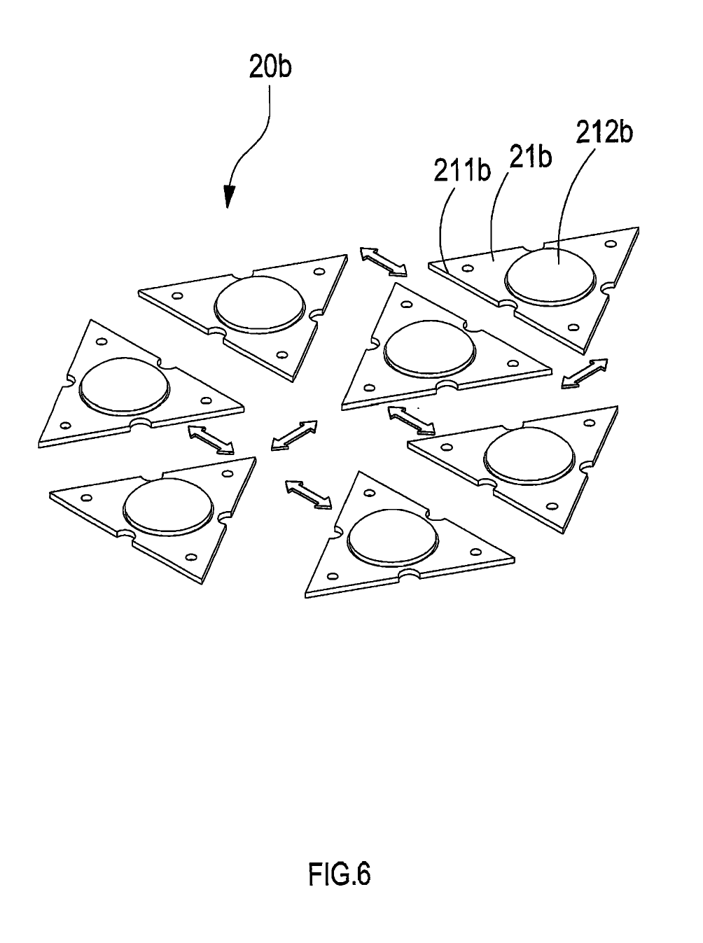

Referring to FIG. 5 and FIG. 6, which show implementation schematic views of a second preferred embodiment of the present invention, and it can be clearly seen from the drawings that a LED module assembly 20b is structurally assembled from a plurality of polygonal LED modules 21b, and the LED modules 21b respectively comprise at least one LED light-emitting element 212b. The lengths of sides 211b of the LED module 21b enable corresponding combination thereof to complete assembly of different types of figures, such as: triangular (but is not limited to such an arrangement combination nor is the number of LED light-emitting elements 212b limited).

Hence, referring to all the drawings, compared to the prior art, the following advantages exist when using the present invention:

1. Design of the polygonal LED modules 21 enable a user to expand the number of the LED modules 21 by himself.

2. Superior area light source.

3. Use of the transformer 10 enables control of a plurality of the LED modules 21 without additional transformers 10, thereby achieving the objective of saving in costs.

In conclusion, the composite structure for polygonal LED of the present invention is clearly able to achieve the effectiveness and objectives as disclosed when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A composite structure for polygonal LED, comprising a transformer controlling a LED (light-emitting diode) module assembly, wherein:
the LED module assembly is a composite structure from a plurality of polygonal LED modules, and the lengths of sides of the LED modules enable corresponding combination thereof, thereby enabling the LED modules to be mutually connected together from any one of the sides.

2. The composite structure for polygonal LED according to claim 1, wherein the LED modules are connected together using screw tightening, solder joining, insertion fastening, drive fitting or adhesive affixing.

3. The composite structure for polygonal LED according to claim 1, wherein the LED modules respectively comprise at least one LED light-emitting element.
